(19) United States
(12) Patent Application Publication
(10) Pub. No.: US 2025/0239810 A1
(43) Pub. Date: Jul. 24, 2025

(54) ELECTRICAL CONNECTOR WITH EASY AND RELIABLE LOCKING AND UNLOCKING

(71) Applicant: Amphenol Technology (Zhuhai) Co., Ltd., Zhuhai (CN)

(72) Inventors: Peng Huang, Zhuhai (CN); Sen Lin, Zhuhai (CN); Ming Weng, Zhuhai (CN)

(73) Assignee: Amphenol Technology (Zhuhai) Co., Ltd., Zhuhai (CN)

(21) Appl. No.: 19/035,765

(22) Filed: Jan. 23, 2025

(30) Foreign Application Priority Data
Jan. 24, 2024 (CN) 202420179365.4
Jan. 24, 2024 (CN) 202420182456.3

(51) Int. Cl. H01R 13/629

(52) U.S. Cl. CPC H01R 13/629

(57) ABSTRACT

An electrical connector to provide easy and reliable locking and unlocking. A locking member may be slidably mounted to a housing of the connector such that it may slide between a locked state in which it is positioned to engage a complementary locking member from a mating connector and an unlocked state in which it is clear of the complementary locking member. The locking member may be biased by an elastic member into the locked state. An activating portion may extend from a base of the locking member, such that when the activating portion is pressed the locking member may slide into the unlocked state. When the activating portion of the locking member is released, the elastic member may push the locking member back to the locked state. The locking member may deflect such that, when in the locked state, the complementary locking member may be inserted into the connector.

### CROSS-REFERENCE TO RELATED APPLICATIONS

This application claims priority to and the benefit of Chinese Patent Application No. 202420179365.4, filed on Jan. 24, 2024. This application also claims priority to and the benefit of Chinese Patent Application No. 202420182456.3, filed on Jan. 24, 2024. The contents of these applications are incorporated herein by reference in their entirety.

### TECHNICAL FIELD

This application relates generally to interconnection systems, such as those including electrical connectors, used to interconnect electronic assemblies.

### BACKGROUND

Cable connectors are widely used in various industries to establish reliable electrical connections between cables or between cables and devices. These connectors play a critical role in ensuring the safe and efficient transmission of electrical signals or power. With advancements in technology and the growing demand for compact, high-performance, and easy-to-use electrical systems, cable connectors have become indispensable components in fields such as telecommunications, automotive, aerospace, and consumer electronics.

### SUMMARY

Aspects of the present disclosure relate to electrical connectors with easy and reliable locking and unlocking.

Some embodiments relate to an electrical connector comprising: a housing member; a locking member comprising a base and an engaging portion extending from a first side of the base; and an elastic member coupling the locking member to the housing member such that the locking member slides with respect to the housing member when the elastic member is pressed by the locking member and returns to a resting state when the locking member stops pressing the elastic member.

Optionally, the housing member comprises a space and a connecting feature protruding into the space; and the elastic member is disposed around at least a portion of the connecting feature of the housing member.

Optionally, the locking member comprises a connecting feature; and the elastic member is disposed around at least a portion of the connecting feature of the locking member.

Optionally, the connecting feature of the locking member and the connecting feature of the locking member are coupled to each other such that the locking member slides with respect to the housing member when the elastic member is pressed by the locking member.

Optionally, the locking member comprises an activating portion extending from a second side of the base; the connector comprises a positioning member partially enclosing the locking member; the positioning member comprising a hole; and the activating portion of the locking member extends through the hole.

Optionally, the engaging portion of the locking member extends out of the positioning member.

Optionally, the housing member comprises a supporting member; and the locking member is movably coupled to the supporting member of the housing.

Optionally, the supporting member is configured to restrain movement of the locking member.

Optionally, the elastic member is integral with the housing member and/or the locking member.

Optionally, the connecting feature of the housing member is a sleeve; and the connecting feature of the locking member is a post at least partially disposed in the sleeve of the housing member.

Optionally, the housing member is a front housing member; and the electrical connector comprises a rear housing member comprising a wall configured to engage an end of the front housing member, and the positioning member extending from the wall towards front.

Optionally, the base of the locking member comprises an opening; the housing member comprises a supporting member protruding into the space; and the locking member is movably mounted to the housing member with the supporting member protruding into the opening of the base of the locking member.

Optionally, the connecting feature of the locking member is a first sleeve; and the connecting feature of the housing member is a second sleeve at least partially disposed in the first sleeve of the locking member.

Optionally, the housing member comprises a protruding member protruding into the space from the side of the space; and the electrical connector comprises a positioning member engaging the protruding member of the housing member and partially enclosing the locking member, the positioning member comprising a hole configured for the activating portion of the locking member to extend therethrough when the locking member is in a locked position.

Optionally, the housing member comprises a supporting member protruding into the space.

Optionally, the supporting member comprises a first subportion connected to the housing member, a second subportion abutting against an end wall of the base of the locking member, and a third subportion abutting against a bottom of the engaging portion of the locking member.

Some embodiments relate to an electrical connector configured to mate with a complementary connector in a mating direction, comprising: a housing member comprising first and second chambers; first and second terminals disposed in the first and the second chambers, respectively, each of the first and second terminals comprising a receptacle mating end and a tail; and a locking member comprising a base coupled to the housing member and configured to move in a first direction perpendicular to the mating direction, and an engaging portion extending from a first side of the base and configured to move in a second direction perpendicular to both the mating direction and the first direction.

Optionally, the electrical connector comprises: an elastic member coupled to the locking member and the housing member such that the locking member is biased by the elastic member into a first position, wherein the locking member comprises an activating portion configured to extend from the housing member when the locking member is in the first position and to compress the clastic member when pressed towards the housing member.

Optionally, the housing member comprises a supporting member; and the locking member is configured to move along the supporting member so as to restrain rotation of the locking member.

Optionally, the housing member comprises a space and a connecting feature protruding into the space from a side of the first chamber; the locking member comprises a connecting feature protruding from the base; and the elastic member is disposed around both the connecting feature of the housing member and the connecting feature of the locking member.

Optionally, the electrical connector comprises a positioning member connected to the housing member and partially enclosing the locking member, wherein the engaging portion comprises a deflectable beam extending out of the positioning member.

Optionally, the tails of the first and second terminals are configured to connect with cables.

Some embodiments relate to a method of operating an electrical connector comprising a locking member having an activating portion and an engaging portion. The method may comprise mating with a complementary connector in a mating direction until the locking member is in a locked position; pressing the activating portion so as to move the engaging portion of the locking member transverse to the mating direction; and releasing the activating portion such that the locking member is pushed back to the locked position.

Optionally, mating with the complementary connector comprises deflecting the engaging portion of the locking member.

Some embodiments relate to an electrical connector. The electrical connector may comprise a front housing member, a locking member, and a rear housing member. The locking member may be slidably mounted to the front housing member with an elastic member that biases the locking member into an engaging position. The locking member may have an engaging portion configured for externally connecting to a mating connector. The rear housing member may comprise a wall and a positioning member, wherein the wall and the positioning member are integrally formed, the wall is in snap-fit with a tail end of the front housing member, the positioning member encapsulates the locking member, the positioning member comprises a hole, and an activating portion on the locking member protrudes out of the hole.

Optionally, a supporting member is arranged on the front housing member, and the locking member is movably coupled to the supporting member.

Optionally, a movement direction of the locking member is perpendicular to a length direction of the positioning member.

Optionally, the front housing member comprises a space, the engaging portion is arranged at the space, and the engaging portion is driven by the activating portion to move in a movement direction perpendicular to a bottom face of the space.

Optionally, the locking member comprises a base, the engaging portion and the activating portion, the base comprises an opening, the supporting member is movably disposed in the opening, and the base, the engaging portion and the activating portion are integrally formed.

Optionally, a groove is arranged at a joint of the engaging portion and the base.

Optionally, the engaging portion comprises a first subportion, a second subportion, and a third subportion joining the first subportion and the second subportion, and the second subportion comprises a protrusion.

Optionally, a width of the protrusion is less than or equal to a width of the second subportion.

Optionally, a sleeve is arranged on the front housing member, a hollow is arranged at one end of the base close to the sleeve, a post is arranged in the hollow, the post is configured for inserting the sleeve, the elastic member is arranged around the sleeve and the post, and the other end of the clastic member is inserted into the hollow and abuts against an inner bottom portion of the hollow.

Some embodiments relate to an electrical connector. The electrical connector may comprise a front housing member, a locking member, and a positioning member. A front housing member may be provided with a first sleeve, wherein an upper end and a lower end of the first sleeve are both provided with a protruding member. A locking member may be provided slidably at the front housing member through an elastic member, wherein an engaging portion is arranged on the locking member, and the engaging portion is configured for externally connecting a mating connector. A positioning member, in snap-fit with the front housing member, wherein a recess may be matched and engaged with the protruding member is arranged in the positioning member, the positioning member is sleeved into the first sleeve, the protruding member is in snap-fit with the recess, the positioning member encapsulates the locking member, the positioning member comprises an hole, and a activating portion on the locking member protrudes out of the hole.

Optionally, the rails are arranged at opposite ends of the protruding member, and the locking member is slidably connected to the rails.

Optionally, a post is arranged in the first sleeve, the post is configured for inserting the locking member, the elastic member is arranged around the post, one end of the elastic member abuts against the front housing member, the other end of the elastic member abuts against the locking member, and the elastic member is configured for driving the activating portion on the locking member to protrude out of the hole.

Optionally, the front housing member comprises a space, the engaging portion is arranged at the space, and the engaging portion is driven by the activating portion to move in a movement direction perpendicular to a bottom face of the space.

Optionally, the locking member comprises a base, the engaging portion and the activating portion which are integrally formed, the base comprises a second sleeve cooperatively connected with the post, the second sleeve is inserted into the first sleeve, and the post is inserted into the second sleeve.

Optionally, the engaging portion comprises a first subportion, a second subportion, and a third subportion joining the first subportion and the second subportion, and the second subportion comprises a protrusion.

Optionally, a width of the protrusion is less than or equal to a width of the second subportion.

Optionally, a supporting member is arranged on the front housing member, the supporting member comprises a first subportion, a second subportion and a third subportion which are integrally formed, the locking member is movably disposed on the supporting member, the first subportion is connected to the front housing member, the second subportion abuts against an end wall of the base, and the third subportion abuts against a lower end of the first subportion.

These techniques may be used alone or in any suitable combination. The foregoing summary is provided by way of illustration and is not intended to be limiting.

### BRIEF DESCRIPTION OF THE DRAWINGS

The above and/or additional aspects and advantages of the present disclosure will become apparent and easy to understand from the descriptions of embodiments with reference to the following drawings. The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1A is a top, rear perspective view of an electrical connector, according to some embodiments.

FIG. 1B is a perspective view of an electronic system, showing the electrical connector of FIG. 1A and a plug connector in a locked state, according to some embodiments.

FIG. 1C is a perspective view of the electronic system of FIG. 1B, showing the electrical connector of FIG. 1A and the plug connector in an unmated state.

FIG. 2 is a partially exploded perspective view of the electrical connector of FIG. 1A.

FIG. 3 is a front, side perspective view of the electrical connector of FIG. 2.

FIG. 4 is another front, side perspective view of the electrical connector of FIG. 2.

FIG. 5A is a perspective view of an electrical connector, according to some embodiments.

FIG. 5B is a perspective view of an electronic system, showing the electrical connector of FIG. 5A and a plug connector in a locked state, according to some embodiments.

FIG. 5C is a perspective view of the electronic system of FIG. 5B, showing the electrical connector of FIG. 5A and the plug connector in an unmated state.

FIG. 6 is a partially exploded, top perspective view of the electrical connector of FIG. 5A.

FIG. 7 is a bottom perspective view of the electrical connector of FIG. 6.

### DETAILED DESCRIPTION

The inventors have recognized and appreciated connector design techniques for making electrical connectors with easy and reliable locking and unlocking. The connector may include a locking member that is movable in a transverse direction relative to connector housing along an axis that is orthogonal to the mating direction of the connector and a mating connector. The locking member may move between a locked and an unlocked position. In some examples, the locking member may be slidably mounted to the connector housing.

The locking member may include an engaging portion configured to engage with a complementary connector. The engaging portion and/or the engaging portion of a complementary locking member of the mating connector optionally may be deflectable such that when locking member is in a locked position and the complementary locking member from a mating connector is pushed toward the locking member, one or both of the engaging portions may deflect, allowing the distal end of the complementary locking member to move past the distal end of the locking member. In this position, the engaging portions may move towards each other and engage, such that the connector and mating connector are locked together.

For unlocking the connectors, the locking member may be moved into an unlocked position. The unlocked position may be sufficiently separated from the locking state along the transverse axis such that the engaging portion of the locking member is besides, rather than aligned with, the engaging portion of the complementary locking member. In this position, the locking member and the complementary locking member are no longer engaged, and the connector and the mating connector are no longer locked to each other and can be easily separated.

Additionally, the connector may include an elastic member, such as a spring, which may bias the locking member into the locked position. An activating portion, extending from the locking member may be pressed, forcing the locking member into the unlocked position. In this example, the clastic member creates a rest state for the locking member in the locked position. In some examples, the locking member may move with respect to a housing member of the connector when the clastic member is compressed by the activating portion of the locking member and return to the resting state when the activating portion is released.

Such a connector provides secure locking of the connector and a complementary connector, because the engaging portion and complementary engaging portion may be configured to securely engage without creating the need for a user attempting to unmate the connector to apply a force that overcomes that engagement. Such secure locking mechanism may be used, for example, in a cable connector, in which forces on the cable may tend to dislodge mated connectors. Alternatively or additionally, spring biasing the locking member into the locked position provides case of operation. The connector and a complementary connector may be mated without moving the locking mechanism, and unlocking, by pressing an external activating portion enable simple operation than, for example, other connectors with sliding locking components that have to be manually moved in both directions.

According to aspects of the present disclosure, an electrical connector may be configured to mate with a complementary connector in a mating direction. In some embodiments, one of the electrical connector and the complementary connector may be a receptacle connector and the other may be a plug connector. The electrical connector may include a housing member configured for holding terminals, and a locking member movably coupled to the housing member so as to easily and reliably lock and unlock the connector from a mating connector. The locking member may include a base, an engaging portion configured to engage with a mating connector, and an activating portion. In some embodiments, the base of the locking member may be configured to move in a first direction perpendicular to the mating direction. The engaging portion of the locking member may be configured to move in a second direction perpendicular to both the mating direction and the first direction. In some embodiments, when the activating portion is pressed, the locking member can move laterally, moving from its locked state to facilitate unlocking without causing damage from forceful manipulation. Such a configuration may enable the activating portion in an ergonomic position (e.g., easily depressed by a user while gripping the connector to separate the connectors).

In some embodiments, the electrical connector may include first and second chambers disposed diagonally, a space between a side of the first chamber and a top of the second chamber, and first and second terminals disposed in the first and the second chambers, respectively. Each terminal may include a receptacle mating end configured to receive a pin of a mating connector, and a tail. In some embodiments, the terminals may be configured for transmitting power and/or signals. In some embodiments, the terminal tails may be configured to connect with cables. For example, the cables may be connected to the terminal tails via suitable methods such as crimp and ultrasonic welding.

In some embodiments, the housing member may include a connecting feature protruding into the space from a side of the first chamber. The locking member may include a connecting feature protruding from the base. The connecting feature of the housing member and the connecting feature of the locking member may be a pair of a sleeve and post, with the post configured to at least partially disposed in the sleeve. The elastic member may be disposed around at least a portion of the pair of the sleeve and post. In some embodiments, the housing member may include a supporting member. The locking member may be movably coupled to the supporting member of the housing. The supporting member may be configured to restrain rotation of the engaging portion of the locking member.

In some embodiments, the electrical connector may include a positioning member partially enclosing the locking member. The positioning member may have a hole for the activating portion of the locking member to extend therethrough.

In some embodiments, a method of manufacturing an electrical connector may including providing a housing member comprising first and second chambers disposed diagonally, a space between a side of the first chamber and a top of the second chamber, and a connecting feature protruding into the space from a side of the first chamber; providing a locking member comprising a base, an engaging portion extending from a first side of the base, a connecting feature protruding from a second side of the base, and an activating portion extending from the second side of the base opposite to the connecting feature; disposing an elastic member around both the connecting feature of the housing member and the connecting feature of the locking member; and disposing a positioning member so as to secure the locking member to the housing member, the positioning member comprising a hole for the activating portion of the locking member to extend therethrough.

These techniques may be used alone or together. Their use is illustrated herein in connection with a power connector, here configured as a receptacle connector with banded terminals. Each banded terminal may receive a pin from a mating connector.

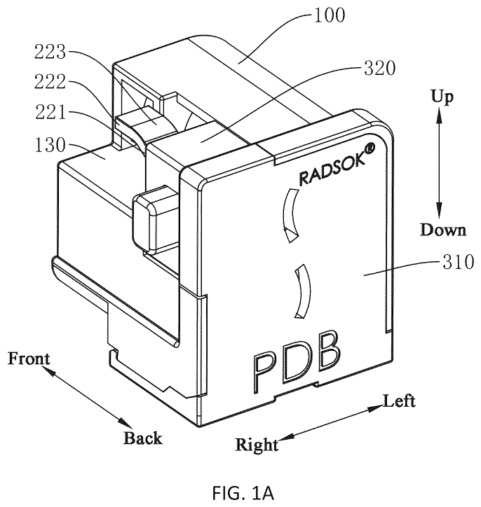

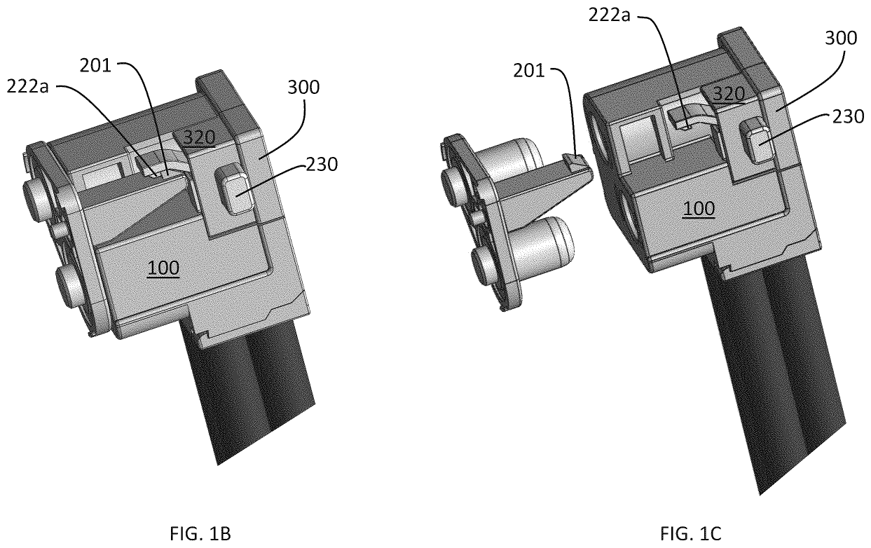

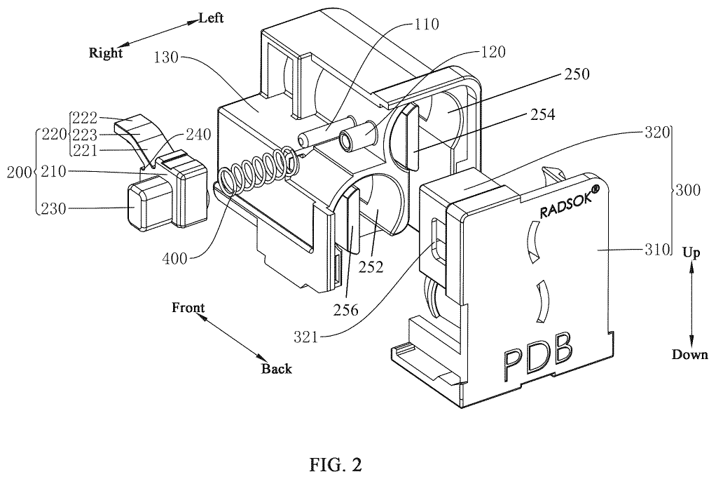

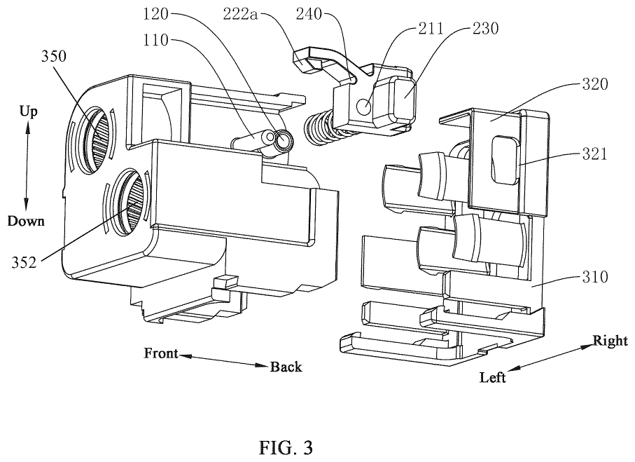

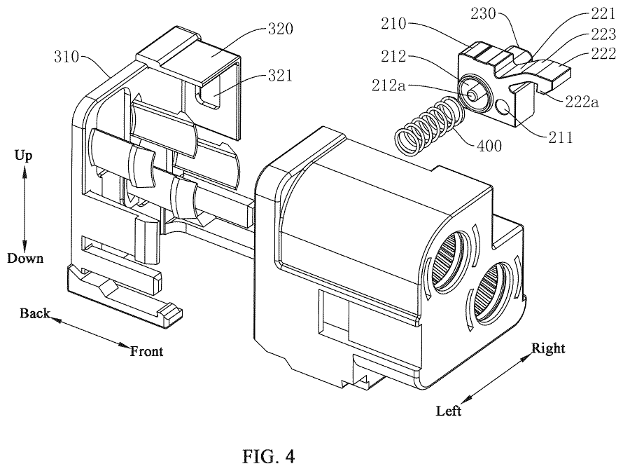

According to aspects of the present disclosure, as shown in FIGS. 1A-4, an electrical connector may comprise a front housing member 100, a rear housing member 300 disposed at a rear of the front housing member 100, and a locking member 200. The rear housing member 300 may comprise a wall 310 and a positioning member 320. The wall 310 and the positioning member 320 may be integrally formed. The wall 310 may be configured to fit with a tail end 258 of the front housing member 100. The positioning member 320 may be configured to secure the locking member 200 to the front housing member 100. The positioning member 320 may include a hole 321 configured for an activating portion 230 of the locking member 200 to protrude out of the hole 321. The rear housing member 300 may be mounted to the front housing member 100 in cooperation with the locking member 200. The rear housing member 300 may be configured to support the locking member 200.

The locking member 200 may be movably coupled to the front housing member 100. The locking member 200 may include an engaging portion 220 configured to engage with a mating connector. The engaging portion 220 may be configured to connect externally to a mating connector. The mating connector may be compatible with the electrical connector. For example, the mating connector may include a hook 201 configured to engage with a protrusion 222a of the locking member 200 at a space 130. The engaging portion may be slidably in a transverse direction relative to connector housing along an axis that is orthogonal to the mating direction of the connector and the mating connector.

During mating, the engaging portion 220 and/or the engaging portion of a complementary locking member of the mating connector optionally may be deflectable such that when the locking member 200 is in a locked position and the complementary locking member from the mating connector is pushed toward the locking member 200, one or both of the engaging portions may deflect, allowing the distal end of the complementary locking member to move past the distal end of the locking member 200. In this position, the engaging portions may move towards each other and engage, such that the connector and mating connector are locked together.

When engaged with a mating connector, the clastic member 400 may bias the locking member 200 to securely lock with the mating connector. During unlocking operation, the locking member 200 to move translationally in a movement direction to disengage from the mating connector. After the disengagement, the clastic member 400 may drive the locking member 200 to return to its resting position. In the illustrated example, the elastic member is a spring, such as a coiled spring, and it is mounted such that it is compressed when the locking member is pushed from its locked position to the unlocked position. This compression provides a spring force on the locking member, biasing it towards the locked position.

For unlocking the connectors, the locking member 200 may be moved into an unlocked position. The unlocked position may be sufficiently separated from the locking state along the transverse axis such that the engaging portion 220 of the locking member 200 is besides, rather than aligned with, the engaging portion of the complementary locking member. In this position, the locking member 200 and the complementary locking member are no longer engaged, and the connector and the mating connector are no longer locked to each other and can be easily separated.

With the activating portion 230, the resting position of the locking member 200 can be constrained, allowing the clastic member 400 to drive the locking member 200 to abut against an inner wall of the positioning member 320. Upon pressing the activating portion 230, the locking member 200 can be translated laterally, disengaging from a locked state. Such a configuration enables unlocking while preventing damage to the locking member 200 that could result from forced manipulation.

Such a connector provides secure locking of the connector and a complementary connector, because the engaging portion and complementary engaging portion may be configured to securely engage without creating the need for a user attempting to unmate the connector to apply a force that overcomes that engagement. Such secure locking mechanism may be used, for example, in a cable connector, in which forces on the cable may tend to dislodge mated connectors. Alternatively or additionally, spring biasing the locking member into the locked position provides case of operation. The connector and a mating connector may be mated without moving the locking mechanism, and unlocking, by pressing an external activating portion enable simple operation than, for example, other connectors with sliding locking components that have to be manually moved in both directions.

In some embodiments, the front housing member 100 may include a supporting member 110. The locking member 200 may be slidably mounted on the supporting member 110. The supporting member 110 may be configured to guide the sliding of the locking member 200 and facilitate directional translational sliding of the locking member 200 and therefore the unlocking operation. The supporting member, for example, may serve as a rail on which the locking member is mounted to slide between a locked and an unlocked position. Such a configuration may restrain rotation of the locking member 5200 to enable secured locking and reduce the risk of overriding.

In some embodiments, a movement direction of the locking member 200 may be perpendicular to a length direction of the positioning member 320. The length direction is a front-rear direction of the positioning member 320.

In some embodiments, the front housing member 100 may include the space 130. The engaging portion 220 may be arranged at the space 130. Upon the activation of the activating portion 230, the engaging portion 220 may move in a movement direction perpendicular to a bottom face of the space 130.

In some embodiments, the locking member 200 may comprise a base 210, the engaging portion 220, and the activating portion 230. The base 210 may include a feature that engages supporting member 110, which in this example is an opening 211. The supporting member 110 is disposed in the opening 211, constraining motion of locking member 200 to a direction along the axis of supporting member 110. In the illustrated example, the base 210, the engaging portion 220 and the activating portion 230 are integrally formed. The locking member 200 has a simple structure, and the integrated molding is convenient for injection molding and manufacturing, and the opening 211 is also convenient for enabling the locking member to slide along the supporting member 110, while constraining translation of the locking member in directions orthogonal to that axis. In some embodiments, the locking member 200 may comprise a groove 240 at a joint of the engaging portion 220 and the base 210. The groove 240 may enable the engaging portion 220 to be more clastic, facilitating locking with the mating connector.

In some embodiments, the engaging portion 220 may comprise a first subportion 221, a second subportion 222, and a third subportion 223 joining the first subportion 221 and the second subportion 222. The second subportion 222 may include a protrusion 222a. The third subportion 223 may enhance the strength of the engaging portion 220, and allow for increased height of the second subportion 222 by the first subportion 221, facilitating locking with the mating connector.

In some embodiments, a width of the protrusion 222a may be less than or equal to a width of the second subportion 222. Such a configuration may enable the protrusion 222a to be easily unengaged from the mating connector when the base 210 slides. The width may be in a left-right direction.

In some embodiments, the front housing member 100 may comprise a sleeve 120. The base 210 may include a hollow 212 at one end adjacent to the sleeve 120. The base 210 may include a post 212a disposed in the hollow 212. The post 212a may be configured to insert into the sleeve 120. The clastic member 400 may be disposed around the sleeve 120 at one end and insert into the hollow 212 at the other end, abutting against an inner bottom portion of the hollow 212. The elastic member 400 may comprise any suitable configuration such as a spiral spring, an elastic sheet, and a rubber block. Although the illustrated elastic member 400 is a component separable from the front housing member 100 and the locking member 200, in some embodiments, the elastic member may be integral with a housing member and/or a locking member.

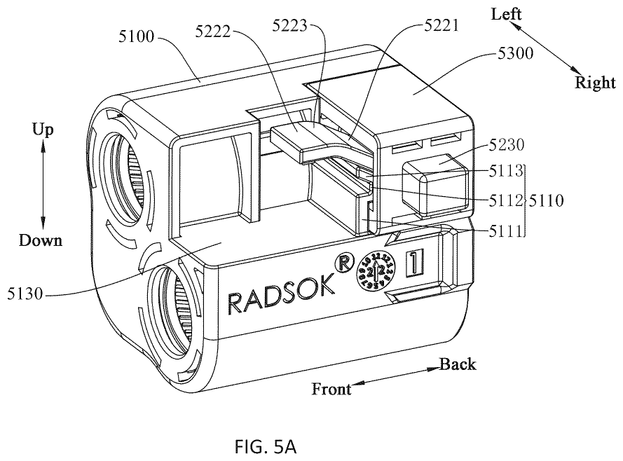

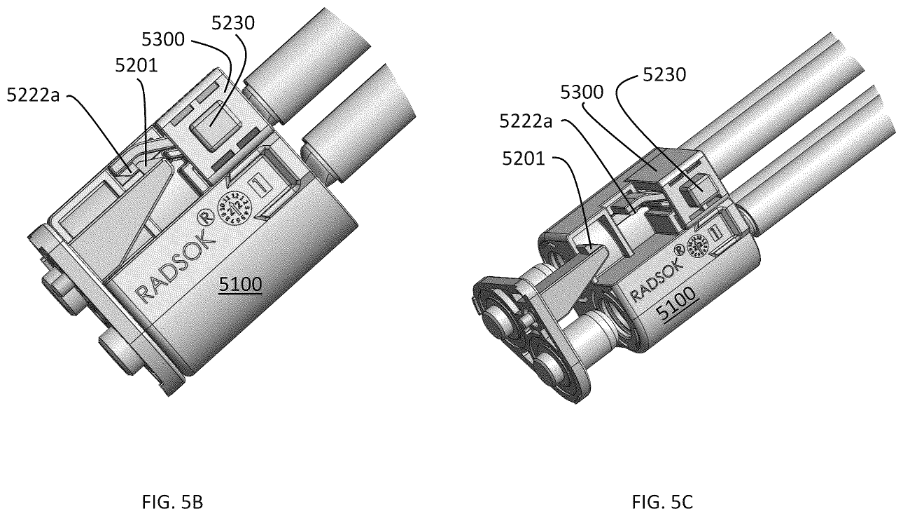

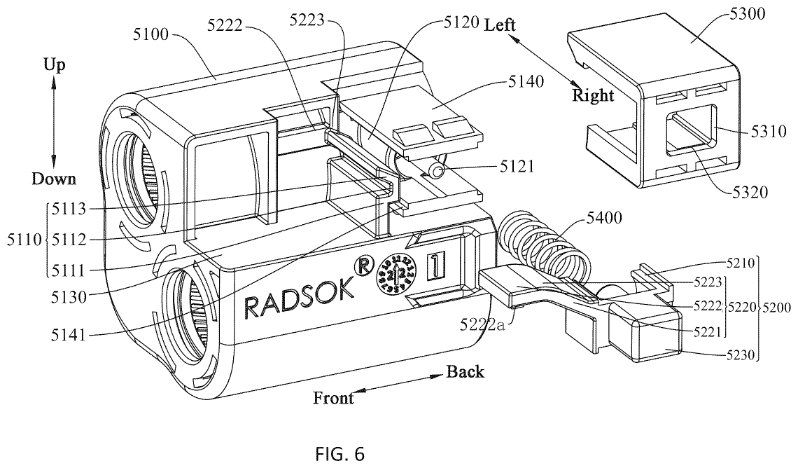

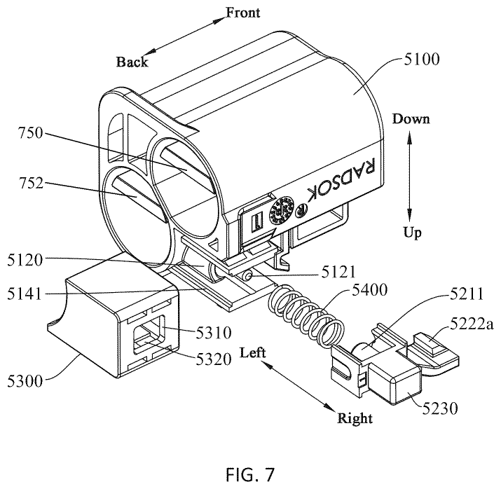

According to aspects of the present disclosure, as shown in FIGS. 5A-7, an electrical connector may comprise a front housing member 5100, a locking member 5200, and a positioning member 5300. The front housing member 5100 may comprise a first sleeve 5120, and protruding members 5140 above and below the first sleeve 5120. The protruding member 5140 may be configured to enable the front housing member 5100 to engage with the positioning member 5300.

The positioning member 5300 may be configured to secure the locking member 5200 to the front housing member 5100. The positioning member 5300 may include a recess 5320 configured to engage with the protruding member 5140. Two protruding members 5140 may enable the positioning member 5300 to be connected with the front housing member 5100 more stably. The positioning member 5300 may be disposed onto the first sleeve 5120 such that the protruding members 5140 fit in corresponding recesses 5320 of the positioning member 5300. The positioning member 5300 may include a hole 5310 configured for an activating portion 5230 of the locking member 5200 to protrude out of the hole 5310.

The locking member 5200 may be movably coupled to the front housing member 5100, for example, via an elastic member 5400. The locking member 5200 may include an engaging portion 5220 configured to engage with a mating connector. The engaging portion 5220 may be configured to connect externally to a mating connector. The mating connector may be compatible with the electrical connector. For example, the mating connector may include a hook 5201 configured to engage with a protrusion 5222a of the locking member 5200 at a space 5130.

When engaged with a mating connector, the elastic member 5400 may drive the locking member 5200 to securely lock with the mating connector. During unlocking operation, the elastic member 5400 may drive the locking member 5200 to move translationally in a movement direction to disengage from the mating connector. After the disengagement, the clastic member 5400 may drive the locking member 5200 to return to its resting position.

With the activating portion 5230, the resting position of the locking member 5200 can be constrained, allowing the clastic member 5400 to bias the locking member 5200 to abut against an inner wall of the positioning member 5300. Upon pressing the activating portion 5230, the locking member 5200 can be translated laterally, disengaging from a locked state. Such a configuration enables unlocking while preventing damage to the locking member 5200 that could result from forced manipulation.

In some embodiments, the protruding member 5140 may include rails 5141 at opposite ends. The locking member 5200 may be movably disposed in the rails 5141. The rails 5141 may enable the locking member 5200 to slide directionally and stably, facilitating the locking member 5200 to be unlocked smoothly when the locking member 5200 is operated (e.g., pressed). Such a configuration may restrain rotation of the locking member 5200 to enable secured locking and reduce the risk of overriding.

In some embodiments, the first sleeve 5120 may have a post 5121 disposed therein. The post 5121 may be configured to insert into the locking member 5200. The elastic member 5400 may be around the post 5121, with one end of the elastic member 5400 abutting against the front housing member 5100 and the other end of the elastic member 5400 abutting against the locking member 5200. The elastic member 5400 may be configured to drive the activating portion 5230 of the locking member 5200 to protrude out of the hole 5310. The first sleeve 5120 and the post 5121 may be arranged to restrain the clastic member 5400, so that the elastic member 5400 can be stably compressed and rebounded in a circumferential direction, facilitating operation of the locking member 5200.

In some embodiments, a movement direction of the locking member 5200 may be perpendicular to a length direction of the positioning member 5300. The length direction may be a front-rear direction of the positioning member 5300.

In some embodiments, the front housing member 5100 may include a space 5130. The engaging portion 5220 may be arranged at the space 5130. Upon the activation of the activating portion 5230, the engaging portion 5220 may move in a movement direction perpendicular to a bottom face of the space 5130.

In some embodiments, the locking member 5200 may comprise a base 5210, the engaging portion 5220, and the activating portion 5230. The base 5210 may include a second sleeve 5211 cooperatively connected with the post 5121. The engaging portion 5220 and the activating portion 5230 may be integrally formed. The second sleeve 5211 may be configured to insert into the first sleeve 5120. The post 5121 may be configured to insert into the second sleeve 5211. Such a configuration may enable the locking member to have a structure that can be easily manufactures such as by injection molding. The second sleeve 5211 may be configured to facilitate the sliding of the base 5210. In some embodiments, the locking member 5200 may comprise a groove 5240 at a joint of the engaging portion 5220 and the base 5210. The groove 5240 may enable the engaging portion 5220 to be more elastic, facilitating locking with the mating connector.

In some embodiments, the engaging portion 5220 may comprise a first subportion 5221, a second subportion 5222, and a third subportion 5223 joining the first subportion 5221 and the second subportion 5222. The second subportion 5222 may include a protrusion 5222a. The third subportion 5223 may enhance the strength of the engaging portion 5220, and allow for increased height of the second subportion 5222 by the first subportion 5221, facilitating locking with the mating connector.

In some embodiments, a width of the protrusion 5222a may be less than or equal to a width of the second subportion 5222. Such a configuration may enable the protrusion 5222a to be easily unengaged from the mating connector when the base 5210 slides. The width may be in a left-right direction.

In some embodiments, the front housing member 5100 may include a supporting member 5110. The locking member 5200 may be movably disposed on the supporting member 5110. The supporting member 5110 may be configured to guide the movement of the locking member 5200 and facilitate directional translational sliding of the locking member 5200 and therefore the unlocking operation.

In some embodiments, the supporting member 5110 may comprise a first subportion 5111, a second subportion 5112, and a third subportion 5113. The supporting member 5110 may be integrally formed. The first subportion 5111 may be connected to the front housing member 5100. The second subportion 5112 may abut against an end wall of the base 5210. The third subportion 5113 may abut against a lower end of the first subportion 5221 of the locking member 5200. The elastic member 5400 may comprise any suitable configuration such as a spiral spring, an elastic sheet, and a rubber block. Although the illustrated clastic member 5400 is a component separable from the housing member 5100 and the locking member 5200, in some embodiments, the elastic member may be integral with a housing member and/or a locking member.

Various aspects are described in this disclosure, which include, but are not limited to, the following aspects:

1. A electrical connector, comprising: a front housing member (e.g., 100); a locking member (e.g., 200), movably coupled to the front housing member (e.g., 100) through an elastic member (e.g., 400), wherein an engaging portion (e.g., 220) is arranged on the locking member (e.g., 200), and the engaging portion (e.g., 220) is configured for externally connecting a mating connector; and an rear housing member (e.g., 300), comprising a wall (e.g., 310) and a positioning member (e.g., 320), wherein the wall (e.g., 310) and the positioning member (e.g., 320) are integrally formed, the wall (e.g., 310) is in snap-fit with a tail end of the front housing member (e.g., 100), the positioning member (e.g., 320) encapsulates the locking member (e.g., 200), the positioning member (e.g., 320) comprises an hole (e.g., 321), and a activating portion (e.g., 230) on the locking member (e.g., 200) protrudes out of the hole (e.g., 321).

2. The electrical connector of aspect 1, wherein a supporting member (e.g., 110) is arranged on the front housing member (e.g., 100), and the locking member (e.g., 200) is movably coupled to the supporting member (e.g., 110).

3. The electrical connector of aspect 2, wherein a movement direction of the locking member (e.g., 200) is perpendicular to a length direction of the positioning member (e.g., 320).

4. The electrical connector of aspect 3, wherein the front housing member (e.g., 100) comprises a space (e.g., 130), the engaging portion (e.g., 220) is arranged at the space (e.g., 130), and the engaging portion (e.g., 220) is driven by the activating portion (e.g., 230) to move in a movement direction perpendicular to a bottom face of the space (e.g., 130).

5. The electrical connector of aspect 3, wherein the locking member (e.g., 200) comprises a base (e.g., 210), the engaging portion (e.g., 220) and the activating portion (e.g., 230), the base (e.g., 210) comprises an opening (e.g., 211), the supporting member (e.g., 110) is movably disposed in the opening (e.g., 211), and the base (e.g., 210), the engaging portion (e.g., 220) and the activating portion (e.g., 230) are integrally formed.

6. The electrical connector of aspect 5, wherein a groove (e.g., 240) is arranged at a joint of the engaging portion (e.g., 220) and the base (e.g., 210).

7. The electrical connector of aspect 5, wherein the engaging portion (e.g., 220) comprises a first subportion (e.g., 221), a second subportion (e.g., 222), and a third subportion (e.g., 223) joining the first subportion (e.g., 221) and the second subportion (e.g., 222), and the second subportion (e.g., 222) comprises a protrusion (e.g., 222a).

8. The electrical connector of aspect 7, wherein: a width of the protrusion (e.g., 222a) is less than or equal to a width of the second subportion (e.g., 222).

9. The electrical connector of any one of aspects 5 to 8, wherein a sleeve (e.g., 120) is arranged on the front housing member (e.g., 100), a hollow (e.g., 212) is arranged at one end of the base (e.g., 210) close to the sleeve (e.g., 120), a post (e.g., 212a) is arranged in the hollow (e.g., 212), the post (e.g., 212a) is configured for inserting the sleeve (e.g., 120), the elastic member (e.g., 400) is arranged around the sleeve (e.g., 120) and the post (e.g., 212a), and the other end of the elastic member (e.g., 400) is inserted into the hollow (e.g., 212) and abuts against an inner bottom portion of the hollow (e.g., 212).

10. A electrical connector, comprising: a front housing member (e.g., 5100), provided with a first sleeve (e.g., 5120), wherein an upper end and a lower end of the first sleeve (e.g., 5120) are both provided with a protruding member (e.g., 5140); a locking member (e.g., 5200), movably coupled to the front housing member (e.g., 5100) through an elastic member (e.g., 5400), wherein an engaging portion (e.g., 5220) is arranged on the locking member (e.g., 5200), and the engaging portion (e.g., 5220) is configured for externally connecting a mating connector; and a positioning member (e.g., 5300), in snap-fit with the front housing member (e.g., 5100), wherein a recess (e.g., 5320) matched and engaged with the protruding member (e.g., 5140) is arranged in the positioning member (e.g., 5300), the positioning member (e.g., 5300) is sleeved into the first sleeve (e.g., 5120), the protruding member (e.g., 5140) is in snap-fit with the recess (e.g., 5320), the positioning member (e.g., 5300) encapsulates the locking member (e.g., 5200), the positioning member (e.g., 5300) comprises an hole (e.g., 5310), and a activating portion (e.g., 5230) on the locking member (e.g., 5200) protrudes out of the hole (e.g., 5310).

11. The electrical connector of aspect 10, wherein rails (e.g., 5141) are arranged at opposite ends of the protruding member (e.g., 5140), and the locking member (e.g., 5200) may be movably disposed in the rails (e.g., 5141).

12. The electrical connector of aspect 11, wherein a post (e.g., 5121) is arranged in the first sleeve (e.g., 5120), the post (e.g., 5121) is configured for inserting the locking member (e.g., 5200), the clastic member (e.g., 5400) is arranged around the post (e.g., 5121), one end of the clastic member (e.g., 5400) abuts against the front housing member (e.g., 5100), the other end of the clastic member (e.g., 5400) abuts against the locking member (e.g., 5200), and the clastic member (e.g., 5400) is configured for driving the activating portion (e.g., 5230) on the locking member (e.g., 5200) to protrude out of the hole (e.g., 5310).

13. The electrical connector of aspect 12, wherein the front housing member (e.g., 5100) comprises a space (e.g., 5130), the engaging portion (e.g., 5220) is arranged at the space (e.g., 5130), and the engaging portion (e.g., 5220) is driven by the activating portion (e.g., 5230) to move in a movement direction perpendicular to a bottom face of the space (e.g., 5130).

14. The electrical connector of aspect 13, wherein the locking member (e.g., 5200) comprises a base (e.g., 5210), the engaging portion (e.g., 5220) and the activating portion (e.g., 5230) which are integrally formed, the base (e.g., 5210) comprises a second sleeve (e.g., 5211) cooperatively connected with the post (e.g., 5121), the second sleeve (e.g., 5211) is inserted into the first sleeve (e.g., 5120), and the post (e.g., 5121) is inserted into the second sleeve (e.g., 5211).

15. The electrical connector of aspect 14, wherein the engaging portion (e.g., 5220) comprises a first subportion (e.g., 5221), a second subportion (e.g., 5222), and a third subportion (e.g., 5223) joining the first subportion (e.g., 5221) and the second subportion (e.g., 5222), and the second subportion (e.g., 5222) comprises a protrusion (e.g., 5222a).

16. The electrical connector of aspect 15, wherein a width of the protrusion (e.g., 5222a) is less than or equal to a width of the second subportion (e.g., 5222).

17. The electrical connector of aspect 15, wherein a supporting member (e.g., 5110) is arranged on the front housing member (e.g., 5100), the supporting member (e.g., 5110) comprises a first subportion (e.g., 5111), a second subportion (e.g., 5112) and a third subportion (e.g., 5113) which are integrally formed, the locking member (e.g., 5200) may be movably disposed on the supporting member (e.g., 5110), the first subportion (e.g., 5111) is connected to the front housing member (e.g., 5100), the second subportion (e.g., 5112) abuts against an end wall of the base (e.g., 5210), and the third subportion (e.g., 5113) abuts against a lower end of the first subportion (e.g., 5221).

18. An electrical connector comprising: a housing member (e.g., 100, 5100); a locking member (e.g., 200, 5200) comprising a base (e.g., 210, 5210) and an engaging portion (e.g., 220, 5220) extending from a first side of the base; and an elastic member (e.g., 400, 5400) coupling the locking member to the housing member such that the locking member slides with respect to the housing member when the elastic member is pressed by the locking member and returns to a resting state when the locking member stops pressing the elastic member.

19. The electrical connector of aspect 18, wherein the housing member comprises a space (e.g., 130, 5130) and a connecting feature (e.g., 120, 5120, 5121) protruding into the space; and the elastic member is disposed around at least a portion of the connecting feature of the housing member.

20. The electrical connector of aspect 19, wherein the locking member comprises a connecting feature (e.g., 212a, 5211); and the elastic member is disposed around at least a portion of the connecting feature of the locking member.

21. The electrical connector of aspect 20, wherein the connecting feature of the locking member and the connecting feature of the locking member are coupled to each other such that the locking member slides with respect to the housing member when the elastic member is pressed by the locking member.

22. The electrical connector of aspect 19, wherein the locking member comprises an activating portion (e.g., 230, 5230) extending from a second side of the base; the connector comprises a positioning member (e.g., 320, 5300) partially enclosing the locking member; the positioning member comprising a hole (e.g., 321, 5320); and the activating portion of the locking member extends through the hole.

23. The electrical connector of aspect 22, wherein the engaging portion of the locking member extends out of the positioning member.

24. The electrical connector of aspect 18, wherein the housing member comprises a supporting member (e.g., 110, 5110); and the locking member is movably coupled to the supporting member of the housing.

25. The electrical connector of aspect 24, wherein the supporting member is configured to restrain movement of the locking member.

26. The electrical connector of any of aspect 18-24, wherein the elastic member is integral with the housing member and/or the locking member.

27. The electrical connector of aspect 20, wherein the connecting feature of the housing member is a sleeve (e.g., 120); and the connecting feature of the locking member is a post (e.g., 212a) at least partially disposed in the sleeve of the housing member.

28. The electrical connector of aspect 22, wherein the housing member is a front housing member; and the electrical connector comprises a rear housing member (e.g., 300) comprising a wall (e.g., 310) configured to engage an end of the front housing member, and the positioning member (e.g., 320) extending from the wall towards front.

29. The electrical connector of aspect 19, wherein the base of the locking member comprises an opening (e.g., 211); the housing member comprises a supporting member (e.g., 110) protruding into the space; and the locking member is movably mounted to the housing member with the supporting member protruding into the opening of the base of the locking member.

30. The electrical connector of aspect 20, wherein the connecting feature of the locking member is a first sleeve (e.g., 5120); and the connecting feature of the housing member is a second sleeve (e.g., 5211) at least partially disposed in the first sleeve of the locking member.

31. The electrical connector of aspect 22, wherein the housing member comprises a protruding member (e.g., 5140) protruding into the space from the side of the space; and the electrical connector comprises a positioning member (e.g., 5300) engaging the protruding member of the housing member and partially enclosing the locking member, the positioning member comprising a hole (e.g., 5320) configured for the activating portion of the locking member to extend therethrough when the locking member is in a locked position.

32. The electrical connector of aspect 19, wherein the housing member comprises a supporting member (e.g., 5110) protruding into the space.

33. The electrical connector of aspect 32, wherein the supporting member comprises a first subportion (e.g., 5111) connected to the housing member, a second subportion (e.g., 5112) abutting against an end wall of the base of the locking member, and a third subportion (e.g., 5113) abutting against a bottom of the engaging portion of the locking member.

34. An electrical connector configured to mate with a complementary connector in a mating direction, comprising: a housing member comprising first and second chambers (e.g., 250, 252); first and second terminals (254, 256) disposed in the first and the second chambers, respectively, each of the first and second terminals comprising a receptacle mating end (e.g., 350, 352) and a tail (e.g., 750, 752); and a locking member (e.g., 200, 5200) comprising a base (e.g., 210, 5210) coupled to the housing member and configured to move in a first direction perpendicular to the mating direction, and an engaging portion (e.g., 220, 5220) extending from a first side of the base and configured to move in a second direction perpendicular to both the mating direction and the first direction.

35. The electrical connector of aspect 34, comprising: an elastic member (e.g., 400, 5400) coupled to the locking member and the housing member such that the locking member is biased by the elastic member into a first position, wherein the locking member comprises an activating portion (e.g., 230, 5230) configured to extend from the housing member when the locking member is in the first position and to compress the elastic member when pressed towards the housing member.

36. The electrical connector of aspect 35, wherein the housing member comprises a supporting member (e.g., 110, 5110); and the locking member is configured to move along the supporting member so as to restrain rotation of the locking member.

37. The electrical connector of aspect 36, wherein the housing member comprises a space (e.g., 130, 5130) and a connecting feature (e.g., 120, 5120, 5121) protruding into the space from a side of the first chamber; the locking member comprises a connecting feature (e.g., 212a, 5211) protruding from the base; and the elastic member is disposed around both the connecting feature of the housing member and the connecting feature of the locking member.

38. The electrical connector of aspect 37, comprising a positioning member (e.g., 320, 5300) connected to the housing member and partially enclosing the locking member, wherein the engaging portion comprises a deflectable beam extending out of the positioning member.

39. The electrical connector of aspect 38, wherein the tails of the first and second terminals are configured to connect with cables.

40. A method of operating an electrical connector comprising a locking member (e.g., 200, 5200) having an activating portion (e.g., 230, 5230) and an engaging portion (e.g., 220, 5220), comprising: mating with a complementary connector in a mating direction until the locking member is in a locked position; pressing the activating portion so as to move the engaging portion of the locking member transverse to the mating direction; and releasing the activating portion such that the locking member is pushed back to the locked position.

41. The method of aspect 40, wherein mating with the complementary connector comprises deflecting the engaging portion of the locking member.

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

As an example, although many creative aspects have been described above with reference to cable connectors, it should be understood that the aspects of the present disclosure are not limited to these. Any one of the creative features, whether alone or combined with one or more other creative features, can also be configured for other types of electrical connectors, such as board connectors, etc.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

In the description of the present disclosure, it is to be understood that orientation or positional relationships indicated by orientation words “front’, “rear,” “upper,” “lower,” “left,” “right,” “transverse direction,” “vertical direction,” “perpendicular,” “horizontal,” “top,” “bottom” and the like are shown based on the accompanying drawings, for the purposes of the case in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, e.g., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also enables that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally Including other elements); etc.

In the claims, as well as in the specification above, all transitional phrases such as “comprising,” “including,” “carrying,” “having,” “containing,” “involving,” “holding,” “composed of,” and the like are to be understood to be open-ended, e.g., to mean including but not limited to. For example, a process, method, system, product or device that contains a series of steps or units need not be limited to those steps or units that are clearly listed, instead, it may include other steps or units that are not clearly listed or are inherent to these processes, methods, products or devices. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

1. An electrical connector comprising:
a housing member;
a locking member comprising a base and an engaging portion extending from a first side of the base; and
an elastic member coupling the locking member to the housing member such that the locking member slides with respect to the housing member when the elastic member is pressed by the locking member and returns to a resting state when the locking member stops pressing the elastic member.

2. The electrical connector of claim 1, wherein:
the housing member comprises a space and a connecting feature protruding into the space; and
the elastic member is disposed around at least a portion of the connecting feature of the housing member.

3. The electrical connector of claim 2, wherein:
the locking member comprises a connecting feature; and
the elastic member is disposed around at least a portion of the connecting feature of the locking member.

4. The electrical connector of claim 3, wherein:
the connecting feature of the locking member and the connecting feature of the locking member are coupled to each other such that the locking member slides with respect to the housing member when the elastic member is pressed by the locking member.

5. The electrical connector of claim 2, wherein:
the locking member comprises an activating portion extending from a second side of the base;
the connector comprises a positioning member partially enclosing the locking member;
the positioning member comprises a hole; and
the activating portion of the locking member extends through the hole.

6. The electrical connector of claim 5, wherein:
the engaging portion of the locking member extends out of the positioning member.

7. The electrical connector of claim 1, wherein:
the housing member comprises a supporting member; and
the locking member is movably coupled to the supporting member of the housing; and
the supporting member is configured to restrain movement of the locking member.

8. The electrical connector of any of claim 1, wherein:
the elastic member is integral with the housing member and/or the locking member.

9. The electrical connector of claim 5, wherein:
the housing member is a front housing member; and
the electrical connector comprises a rear housing member comprising a wall configured to engage an end of the front housing member, and the positioning member extending from the wall towards front.

10. The electrical connector of claim 2, wherein:
the base of the locking member comprises an opening;
the housing member comprises a supporting member protruding into the space; and
the locking member is movably mounted to the housing member with the supporting member protruding into the opening of the base of the locking member.

11. The electrical connector of claim 5, wherein:
the housing member comprises a protruding member protruding into the space from the side of the space; and
the electrical connector comprises a positioning member engaging the protruding member of the housing member and partially enclosing the locking member, the positioning member comprising a hole configured for the activating portion of the locking member to extend therethrough when the locking member is in a locked position.

12. The electrical connector of claim 2, wherein:
the housing member comprises a supporting member protruding into the space; and
the supporting member comprises a first subportion connected to the housing member, a second subportion abutting against an end wall of the base of the locking member, and a third subportion abutting against a bottom of the engaging portion of the locking member.

13. An electrical connector configured to mate with a complementary connector in a mating direction, comprising:
a housing member comprising first and second chambers;
first and second terminals disposed in the first and the second chambers, respectively, each of the first and second terminals comprising a receptacle mating end and a tail; and
a locking member comprising a base coupled to the housing member and configured to move in a first direction perpendicular to the mating direction, and an engaging portion extending from a first side of the base and configured to move in a second direction perpendicular to both the mating direction and the first direction.

14. The electrical connector of claim 13, comprising:
an elastic member coupled to the locking member and the housing member such that the locking member is biased by the elastic member into a first position,
wherein the locking member comprises an activating portion configured to extend from the housing member when the locking member is in the first position and to compress the elastic member when pressed towards the housing member.

15. The electrical connector of claim 14, wherein:
the housing member comprises a supporting member; and
the locking member is configured to move along the supporting member so as to restrain rotation of the locking member.

16. The electrical connector of claim 15, wherein:
the housing member comprises a space and a connecting feature protruding into the space from a side of the first chamber;
the locking member comprises a connecting feature protruding from the base; and
the elastic member is disposed around both the connecting feature of the housing member and the connecting feature of the locking member.

17. The electrical connector of claim 16, comprising:
a positioning member connected to the housing member and partially enclosing the locking member,
wherein the engaging portion comprises a deflectable beam extending out of the positioning member.

18. The electrical connector of claim 17, wherein:
the tails of the first and second terminals are configured to connect with cables.

19. A method of operating an electrical connector comprising a locking member having an activating portion and an engaging portion, comprising:
mating with a complementary connector in a mating direction until the locking member is in a locked position;
pressing the activating portion so as to move the engaging portion of the locking member transverse to the mating direction; and
releasing the activating portion such that the locking member is pushed back to the locked position.

20. The method of claim 19, wherein:
mating with the complementary connector comprises deflecting the engaging portion of the locking member.
